(19) United States
(12) Patent Application Publication
(10) Pub. No.: US 2026/0341148 A1
(43) Pub. Date: Oct. 29, 2026

(54) A FILE FORMAT FOR EFFICIENT STORAGE AND ACCESS OF DATA

(71) Applicant: Tesla, Inc., Austin, TX (US)

(72) Inventors: Tim ZAMAN, Austin, TX (US); Alon DAKS, Austin, TX (US)

(73) Assignee: Tesla, Inc., Austin, TX (US)

(21) Appl. No.: 19/115,181

(22) PCT Filed: Sep. 29, 2023
(86) PCT No.: PCT/US2023/034173

§ 371 Date: Mar. 25, 2025

Related U.S. Application Data
(60) Provisional application No. 63/378,012, filed on Sep. 30, 2022.
(60) Provisional application No. 63/377,954, filed on Sep. 30, 2022.

(51) Int. Cl. G08G 1/01; G06F 16/13; G06F 16/18; G06F 16/22

(52) U.S. Cl. CPC G08G 1/0112; G06F 16/13; G06F 16/18; G06F 16/221; G08G 1/0133

(57) ABSTRACT

Systems and methods can include a computing system obtaining data including a plurality of data elements associated with a plurality of indices, where each index is associated with one or more data elements, generating a data file storing the plurality of data elements according to a predefined file format including a header and a plurality of data rows, where each data row corresponds to a respective index and storing the one or more data elements associated with the respective index, and the header includes, for each row, an association between the respective index and a corresponding data offset indicative of a memory position of the data row, determining, using an indication of a first index and the header, a first memory position of a data row corresponding to the first index; and accessing, using the first memory position, at least one data element associated with the first index.

### CROSS-REFERENCE TO RELATED PATENT APPLICATIONS

The present application claims priority to U.S. Provisional Application No. 63/377,954, filed Sep. 30, 2022, and U.S. Provisional Application No. 63/378,012, filed Sep. 30, 2022, which are incorporated herein by reference in its entirety for all purposes.

### TECHNICAL FIELD

The present disclosure generally relates to efficient techniques for storage and access of data. In particular, the current disclosure relates to a new file format and systems and methods using the file format for a more efficient storage of data and accelerated data access.

### BACKGROUND

Autonomous navigation technology used for autonomous vehicles and robots (collectively, egos) has become ubiquitous due to rapid advancements in computer technology. These advances allow for safer and more reliable autonomous navigation of egos. Egos often need to navigate through complex and dynamic environments and terrains that may include vehicles, traffic, pedestrians, cyclists, and various other static or dynamic obstacles. Understanding the egos' surroundings is necessary for informed and competent decision-making to avoid collisions.

### SUMMARY OF THE INVENTION

Systems, devices and methods described herein provide efficient and techniques for storing and accessing data. In particular, the systems, devices and methods described herein enable a new file format leading to a more efficient use of memory resources when storing data and faster access of the stored data. The new file format may be used in applications involving a relatively large amount of data and a relatively large number of system input/output operations, such as training of machine learning (ML) models. In such applications, the amount of memory used to store data can be reduced and significant reductions can be achieved in the number of system input/output operations used and processing time of the system input/output operations. For example, for ML models or artificial intelligence (AI) models used to predict or sense the surroundings of egos, such as occupancy networks, the training of such models is extremely time consuming. The systems, devices and methods described herein significantly accelerate the training and/or validation of such models by reducing the amount of time used to read and/or write training data pieces. Also, the systems, devices and methods described herein lead to more efficient use of processing and memory resources.

According to at least one aspect, a method can comprise obtaining, by a processor, ego navigation data including a plurality of data elements associated with a plurality of indices, each index associated with one or more data elements, the ego navigation data determined based on data captured by at least one sensor of an ego; generating, by the processor, a data file storing the data according to a predefined file format including a header and a plurality of data rows, such that each data row corresponds to a respective index and storing the one or more data elements associated with the respective index, and the header includes, for each data row, an association between the respective index and a corresponding data offset indicative of a memory position of the data row; determining, by the processor, using an indication of a first index and the header, a first memory position of a data row corresponding to the first index; accessing, by the processor, using the first memory position, at least one data element associated with the first index; and using, by the processor, the at least one data element associated with the first index to train a machine learning (ML) model.

In some implementations, the ego navigation data can be used to train an occupancy network of the ego, the occupancy network used to predict or sense surroundings of the ego. In some implementations, the plurality of indices can include a plurality of timestamps or a plurality of time values. In some implementations, the data file can be a read-only data file.

In some implementations, the data can further include at least one other data element that is associated with all of the plurality of indices. The method can further comprise determining, by the processor, that the at least one other data element is associated with all of the plurality of indices; and storing, by the processor, the at least one other data element prior to the plurality of data rows in the data file.

In some implementations, the data file can store the plurality of data elements according to a plurality of columns, where each column represents a corresponding data field. The method can further comprise arranging the plurality of columns according to an increasing order of data sizes associated with the plurality of data columns.

In some implementations, the plurality of data elements can include a plurality of tensors and each data row can store one or more tensors associated with the respective index corresponding to the data row. The method can further comprise at least one of transposing, by the processor, at least a subset of the tensors before storing in the data file; or encrypting, by the processor, at least a subset of the tensors before storing in the data file.

In some implementations, the method can further comprise receiving, by the processor, a request for the at least one data element associated with the first index, the request including the indication of the first index; and determining, by the processor, the first index using the indication.

In some implementations, accessing the at least one data element associated with the first index can include skipping, by the processor, upon determining the first memory position of the data row corresponding to the first index, from a second memory position associated with the header to the first memory position.

According to at least one other aspect, a computing system can comprise a processor and a memory storing executable instructions. The executable instructions, when executed by the processor, cause the computer system to obtain ego navigation data including a plurality of data elements associated with a plurality of indices, each index associated with one or more data elements, the ego navigation data determined based on data captured by at least one sensor of an ego; generate a data file storing the plurality of data elements according to a predefined file format including a header and a plurality of data rows, where each data row corresponds to a respective index and storing the one or more data elements associated with the respective index, and the header includes, for each row, an association between the respective index and a corresponding data offset indicative of a memory position of the data row; determine, using an indication of a first index and the header, a first memory position of a data row corresponding to the first index; access, using the first memory position, at least one data element associated with the first index; and use the at least one data element associated with the first index to train a machine learning (ML) model.

In some implementations, the ego navigation data can be used to train an occupancy network of the ego, the occupancy network used to predict or sense surroundings of the ego. In some implementations, the plurality of indices can include a plurality of timestamps or a plurality of time values. In some implementations, the data file can be a read-only data file.

In some implementations, the data can further include at least one other data element that is associated with all of the plurality of indices. The executable instructions, when executed by the processor, further cause the computer system to determine that the at least one other data element is associated with all of the plurality of indices; and store the at least one other data element prior to the plurality of data rows in the data file.

In some implementations, the executable instructions, when executed by the processor, cause the computer system to store the plurality of data elements according to a plurality of columns in the data file, each column representing a corresponding data field; and arrange the plurality of columns according to an increasing order of data sizes associated with the plurality of data columns.

In some implementations, the plurality of data elements can include a plurality of tensors and each data row can store one or more tensors associated with the respective index corresponding to the data row. The executable instructions, when executed by the processor, cause the computer system to store the plurality of data elements according to perform at least one of transpose at least a subset of the tensors before storing in the data file; or encrypt at least a subset of the tensors before storing in the data file.

In some implementations, the executable instructions, when executed by the processor, further cause the computer system to receive a request for the at least one data element associated with the first index, where the request includes the indication of the first index; and determine the first index using the indication.

In some implementations, in accessing the at least one data element associated with the first index, the executable instructions, when executed by the processor, cause the computer system to skip, upon determining the first memory position of the data row corresponding to the first index, from a second memory position associated with the header to the first memory position.

According to at yet another aspect, a non-transitory computer-readable medium can store computer code instructions thereon. The computer code instructions when executed by a processor can cause the processor to obtain ego navigation data including a plurality of data elements associated with a plurality of indices, each index associated with one or more data elements, the ego navigation data determined based on data captured by at least one sensor of an ego; generate a data file storing the plurality of data elements according to a predefined file format including a header and a plurality of data rows, where each data row corresponds to a respective index and storing the one or more data elements associated with the respective index, and the header includes, for each row, an association between the respective index and a corresponding data offset indicative of a memory position of the data row; determine, using an indication of a first index and the header, a first memory position of a data row corresponding to the first index; access, using the first memory position, at least one data element associated with the first index; and use the at least one data element associated with the first index to train a machine learning (ML) model.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system, according to an embodiment.

FIG. 1B illustrates various sensors associated with an ego according to an embodiment.

FIG. 1C illustrates the components of a vehicle, according to an embodiment.

FIG. 2 illustrates a block diagram of a video training system, according to an embodiment.

FIG. 3 illustrates a flow chart diagram of a method for a flow chart diagram of a method 300 for efficient storing and access of data, according to an embodiment.

FIG. 4 illustrates a diagram depicting an example arrangement of data elements in a data file according to the file format with a plurality of rows, according to an embodiment.

FIG. 5 illustrates a diagram of an example layout of a memory layout of the file described in relation with FIG. 4, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Training of relatively complex ML models or AI models, such as ML models for sensing or predicting the surrounding of an ego, is typically very time consuming and involves the use of a large amount of training data. The training usually consumes significant amount of processing power, bandwidth and memory capacity. In particular, the training includes a relatively large amount of training iterations. At each iterations, a significant amount of data may be fed as input to a training module. As such, the training typically involves a large amount of system input/output operations that add to the complexing of the training of the ML model.

In the current disclosure, a new file format is introduced enhance the efficient of storage and access of data. While described herein mainly in relation to training of ML models, the file format can be used in other applications. According to the file format, data can be stored in a plurality of indexed data rows, or more generally a plurality of indexed data segments. A file header can store the indices of the data rows in association with corresponding data offsets of the data rows (or data segments). The header allows for random access of any data row or data segment of a data file generated according to the file format without having to read the data file all the way to the data row of interest. In other words, when reading the data file, a processor or a computing system can parse the header determine a data offset of the data row (or data segment) of interest and, in response, move or skip to a memory position corresponding to the data offset to read the data row or data segment. As discussed in further detail below, the file format and the systems, devices and methods described herein enable efficient storage of data, relative fast access of data and reduced usage of processing power.

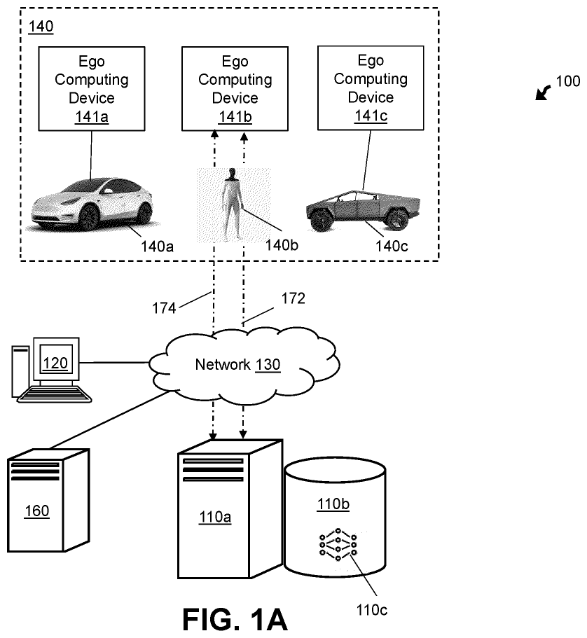

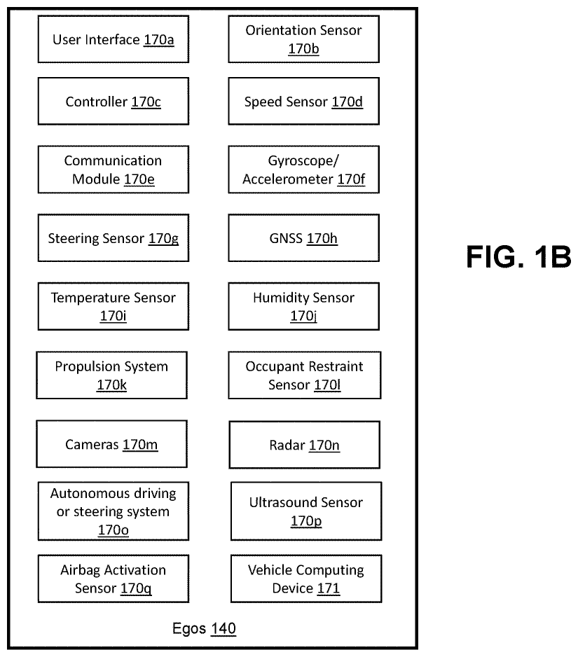

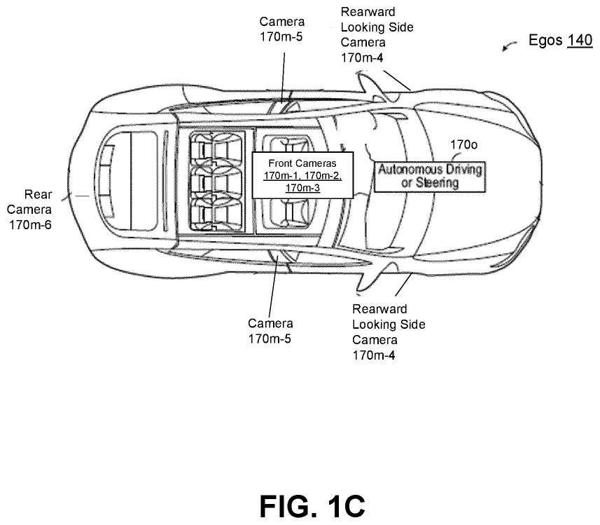

FIG. 1A is a non-limiting example of components of a system in which the methods and systems discussed herein can be implemented. For instance, an analytics server may train an AI model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to an embodiment. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 170o). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how enhanced and efficient handling of data, such as training data for training and/or validating the AI model(s) 110c and/or other ML models, a file format having a header and a plurality of indexed data segments can be used to store and/or access the data. Given data set including a plurality of data elements associated with a plurality of indices, e.g., timestamps or time values, where each index is associated with one or more corresponding data elements, the file format enables storing the data set in a plurality of data rows or data segments of a data file. Each data row or data segment can be correspond to a corresponding index or timestamp, and can store data elements associated with the corresponding index or timestamp. When storing the data set in the data file, a computer system can store in the header the indices of the data rows or data segments in association with data offsets of the data rows or data segments. Specifically, the computer system can store in the header, for each data row or data segment, the corresponding index (or timestamp) in association with the corresponding data offset. For a data field or data variable that is the same for all indices, the computer system can store a single instance of the data field or data variable in the data file, e.g., before the data rows or data segments, to avoid unnecessary redundancy and reduce the amount of data written or stored in the data file.

The file format can be associated with or can have system read and write operations that are specific to the file format. The write operation can be configured to write or store data in data files of the file format according to a predefined arrangement including the header and the data rows or data segments. Specifically, the write operation can enable writing data elements associated with a given index in the data row or data segment corresponding to the data index. The write operation can also enable generating or writing the header, e.g., at the beginning of the data file, to include the indices of the data rows or data segments in association with corresponding data offsets of the data rows or data segments.

The read operation can enable reading the header first to identify data offset(s) of data row(s) of interest and then move to memory positions corresponding to the data offsets to read or parse the data rows or data segments of interest. In other words, a read operation can receive one or more indices of one or more rows (or indication(s) thereof) as input and use the input one or more indices to determine data offset(s) of the one or more rows from the header. The read operation can be configured to move straight to the memory position(s) corresponding to data offset(s) in order to read or parse the one or more rows indicated by the input one or more indices.

The file format and the systems, devices and methods described herein result in about 11% decrease in the size of data files of the new file format compared to other file formats. Also, the number of system input/output operations used per unit time, e.g., IOPS, can be reduced by a factor of four. This implies a saving in memory usage by about 11% and a reduction in processing time by at least a factor of four.

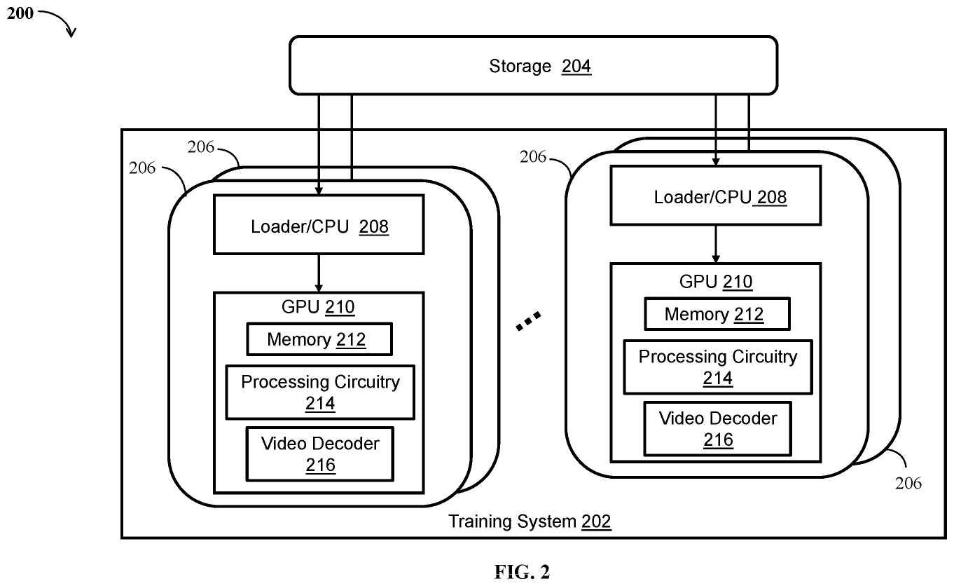

FIG. 2 illustrates a block diagram of computer environment 200 for training ML models, according to an embodiment. The computer environment 200 can include a training system 202 for training ML models and a data storage system 204 for storing training data and/or validation data. The training system 202 can include a plurality of training nodes (or processing nodes) 206. Each training node 206 can include a respective data loader (or data loading device) 208 and a respective graphical processing unit (GPU) 210. Each GPU 210 can include a memory, e.g., cache memory, 212, a processing circuitry 214 and one or more video decoders 216.

The data storage system 204 can include, or can be, a distributed storage system. For instance, the data storage system 204 can have an infrastructure that can split data across multiple physical servers, such super computers. The data storage system 204 can include one or more storage clusters of storage units, with a mechanism and infrastructure for parallel and accelerated access of data from multiple nodes or storage units of the storage cluster(s). For example, the data storage system 204 can include enough data links and bandwidth to deliver data to the training nodes 206 in parallel or simultaneously.

The data storage system 204 can include sufficient memory capacity to store millions or even billions of video frames, e.g., in compressed form. For example, the data storage system 204 can have a memory capacity to store multiple petabytes of data, e.g., 10, 20 or 30 petabytes. The data storage system 204 can allow for thousands of video sequences to be moving in and/or out of the data storage system 204 at any time instance. The relatively huge size and bandwidth of the data storage system 204 allows for parallel training of one or more ML models as discussed below.

The training system 202 can be implemented as one or more physical servers, such as server 110a. For instance, the training system 202 can be implemented as one or more supercomputers. Each supercomputer can include thousands of processing or training nodes 206. The training nodes 206 can be configured or designed to support parallel training of one or more ML models, such as the AI model(s) 110c. Each training node 206 can be communicatively coupled to the data storage system 204 to access data training data and/or validation data stored therein.

Each training node 206 can include a respective data loader 208 and a respective GPU 210 that are communicatively coupled to each other. The data loader 208 can be (or can include) a processor or a central processing unit (CPU) for handling data requests or data transfer between the corresponding GPU 210, e.g., the GPU 210 in the same training node 206, and the data storage system 204. For example, the GPU 210 can request one or more video sequences captured by one or more of the cameras 170m described in relation with FIG. 1C. For instance, the front or forward-looking cameras 170m-1, 170m-2 and 170m-3, the rearward looking side cameras 170m-4, the side cameras 170m-5 and the rear camera 170m-6 can simultaneously capture video sequences and send the video sequences to and stored in the data storage system 204 for storing. In some implementations, the data storage system 204 can store video sequences that are captured simultaneously by multiple cameras, such as cameras 170m, of the ego 140 as a bundle or a combination of video sequences that can be delivered together to a training node 206. For example, the data storage system 204 can maintain additional data indicative of which video sequences were captured simultaneously by the cameras 170m or represent the same scene from different camera angles. The data storage system 204 may maintain, e.g., for each stored video sequence, data indicative of an ego identifier, a camera identifier and a time instance associated with the video sequence.

The training nodes 206 can simultaneously train one or more ML models, e.g., in parallel, using video data captured by the cameras 170m of the ego 140 and stored in the data storage system 204. In some implementations, the video data can be captured by cameras 170m of multiple egos 140. In a training node 206, the corresponding data loader 208 can request video data of one or more video sequence(s) simultaneously captured during a time interval by one or more cameras 170m of an ego 140 from the data storage system 204 and send the received video data to the corresponding GPU 210 for use to execute a training step (or validation step) when training the ML model. The video data can be in compressed form. For instance, the video sequences can be encoded by encoders integrated or implemented in the ego 140. Each data loader 208 can have sufficient processing power and bandwidth to deliver video data to the corresponding GPU 210 in a way to keep the GPU 210 busy. In other words, the GPU 210 can be configured or designed, e.g., in terms of processing power and bandwidth, to request video data of a bundle of compressed video sequences from the data storage system 204 and deliver the video to the GPU 210 in a time duration less than or equal to the average time consumed by the GPU 210 to process a bundle of video sequences.

Each GPU 210 can include a corresponding internal memory 212, such as a cache memory, to store executable instructions for performing processes described herein, received video data of one or more video sequences, decoded video frames, features extracted from decoded video frames, parameters or data of the trained ML model and/or other data used to train the ML model. The memory 212 can be large enough to store all the data needed to execute a single training step. As used herein, a training step can include receiving and decoding video data of a one or more video sequences (e.g., a bundle of video sequences captured simultaneously by one or more cameras 170m of an ego 140), extracting features from the decodes video data and using the extracted features to update parameters of the ML model being trained or validated.

Each GPU 210 can include a processing circuitry 214 to execute processes or methods described herein. The processing circuitry 214 can include one or more microprocessors, a multi-core processor, a digital signal processor (DSP), one or more logic circuits or a combination thereof. The processing circuitry 214 can execute computer code instructions, e.g., stored in the memory 212, to perform processes or methods described herein.

The GPU 210 can include one or more video decoder 216 for decoding video data received from the data storage system 204. The one or more video decoders 216 can include hardware video decoder(s) integrated in the GPU 110 to accelerate video decoding. The one or more video decoders 216 can be part of the processing circuitry 214 or can include separate electronic circuit(s) communicatively coupled to the processing circuitry 214.

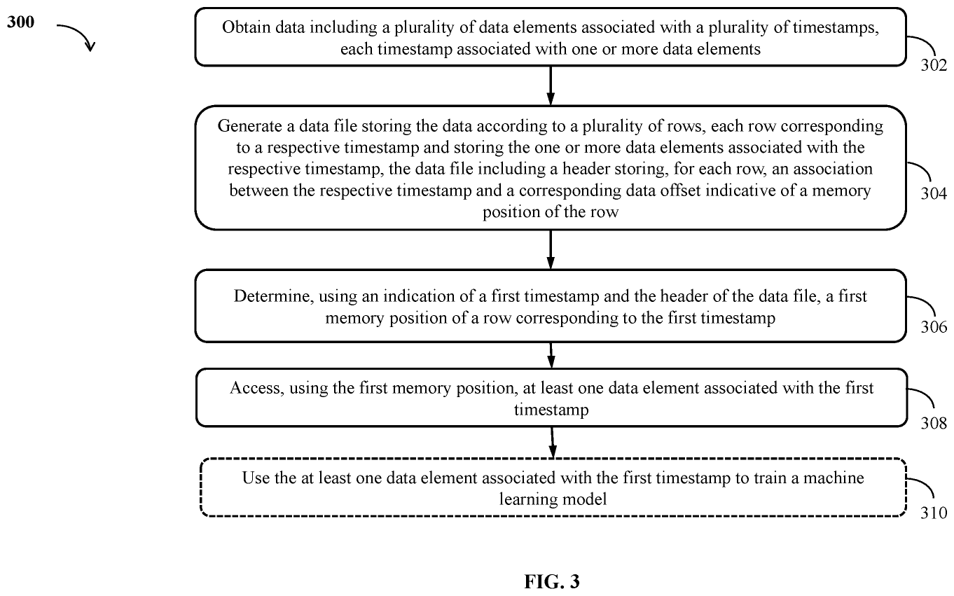

Each GPU 210 can be configured or designed to handle or execute a training step without using any external resources. The GPU 210 can include sufficient memory capacity and processing power to execute a training step. Processes for storing and accessing training data performed by a training node 206 or a corresponding GPU 210 are described in further detail below in relation to FIGS. 3-56.

Referring now to FIG. 3, a flow chart diagram of a method 300 for efficient storing and access of data, according to an embodiment. In brief overview, the method 300 can include obtaining data including a plurality of data elements associated with a plurality of timestamps where each timestamp can be associated with one or more data elements (STEP 302), and generating a data file storing the data according to a predefined file format having a plurality of rows, where each row corresponds to a respective timestamp and stores the one or more data elements associated with the respective timestamp, and the data file includes a header storing, for each row, an association between the respective timestamp and a corresponding data offset indicative of a memory position of the row (STEP 304). The method 300 can include determining, using an indication of a first timestamp and the header of the data file, a first memory position of a row corresponding to the first timestamp (STEP 306), and accessing at least one data element associated with the first timestamp using the first memory position (STEP 308). The method 300 can optionally include using the at least one data element associated with the first timestamp to tarin a training model (STEP 310).

The method 300 can be fully implemented, performed, or executed by any of the CPUs or loaders 208, any of the GPUs 210 and/or other computing devices (or computer systems) of the computer environment 200 or of the system 100. For instance, the GPU 210 can perform method 300 after decoding the selected (or indicated) image frames and extracting corresponding image features. The GPU 210 can store the extracted features together with other training data in a data file according to method 300. The method 300 or any step thereof can be implemented as executable instructions that can be stored in a memory and executed by one or more processors.

The method 300 can include a computer system including a memory and one or more processors, e.g., GPU 210, obtaining data including a plurality of data elements associated with a plurality of timestamps where each timestamp can be associated with one or more data elements (STEP 302). In some implementations, the data can include training data for training or validating one or more machine learning (ML) models. For instance, the data can include data to train and/or validate the AI model(s) 110c or occupancy networks. For example, the data can include ground truth data, features extracted from image frames decoded by the video decoder(s) 216, interference outputs, a map of a geographic location of the ego 140, velocity or speed values of the ego 140, attributes of the ego 140 (e.g., make and model, fuel level, battery state of charge, etc.), maximum allowed speed, sensor data generated by one or more sensors of the ego 140, other type(s) of data and/or a combination thereof. Obtaining the data can include receiving the data or a portion thereof (e.g., from data storage system 204), generating the data or a portion thereof and/or retrieving the data or a portion thereof from a memory, e.g., memory 212.

In some implementations, the data can include or can be ego navigation data that is determined based on data captured by at least one sensor of an ego, such the sensors described in relation to FIG. 1B. The data can include a plurality of data elements. As used herein, a data element can be a parameter value, a tensor, or a text string, among others. For example, the GPU 210 can group features extracted from a single image frame into a single tensor. In some implementations, the GPU 210 can group features extracted from multiple image frames, e.g., captured by the cameras 170m at substantially the same time instance (considering non-synchronization between the cameras 170m and/or corresponding encoders), into a single tensor. Also, road data, such as traffic signs, traffic lights, speed limit, etc., at a given time instance can be grouped or arranged into a corresponding tensor. Some sensor data, such as ego velocity, can be processed as single parameters values. Ego attributes, such as a vehicle make and model, engine type, among others, can be expressed as text strings or numerical values.

The plurality of data elements can be associated with a plurality of timestamps or time value. Each timestamp (or time value) can be associated with one or more data elements. For example, the GPU 210 can associate each set of features extracted from a decoded image frame with the timestamp of the image frame. Also, other received training data, such as ego velocity values, other sensor data from ego sensors, map data, etc., can be associated with the timestamps depending, for example, on the time instance at which each piece or set of training data was captured or recorded. For example, each velocity value can be associated with a timestamp or time value indicative of the time instance at which the velocity value was recorded at the ego 140. The association between the timestamps and the data elements can be performed at ego 140, e.g., when the data elements are captured or recorded, in the training system 202 or a combination of both. The timestamps (or time values) can be equal to timestamps of image frames of video sequences captured by the camera(s) 170m or some other time values.

The method 300 can include the GPU 210 or other computer system generating a data file storing the data according to a predefined file format having a plurality of rows, wherein each row corresponds to a respective timestamp and stores the one or more data elements associated with the respective timestamp, and wherein the data file includes a header storing, for each row, an association between the respective timestamp and a corresponding data offset indicative of a memory position of the row (STEP 304). The GPU 210 or some other computer system can generate the data file and store the data elements in corresponding rows of the data files. The GPU 210 or other computer system can generate the data file and store the data therein according to a predefined file format including a header and one or more indexed rows. The indexing or indices of the rows together with corresponding memory positions can be specified in the header.

In generating the data file, the GPU 210 or other computer system can determine a total number of rows of the data file, e.g., based on the total number of timestamps (or time values), an associated each row with a corresponding timestamp (or time value). The GPU 210 or other computer system can arrange the rows according to an increasing order of corresponding timestamps (or time values). The GPU 210 or other computer system can determine or identify the data elements to be stored in each row based on the association between the data elements and the timestamps and the association between the rows and the timestamps. In particular, the GPU 210 or other computer system can determine to store data elements associated with a given timestamp in the row corresponding to the same timestamp. In determining the arrangement of the data elements in the data file, the GPU 210 or other computer system can determine or create a plurality of columns of the data file. Each column can correspond to or represent a separate data field, data category or data type. For example, each column of the data file can correspond to a data parameter or a type of tensor.

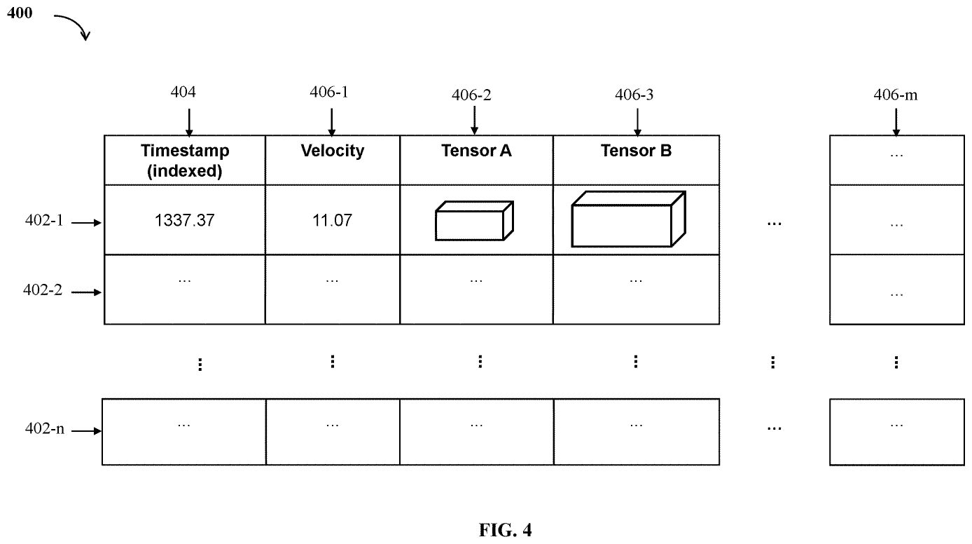

Referring now to FIG. 4, an example arrangement 400 of data elements in a data file according to the file format with a plurality of rows is shown, according to an example embodiment. The GPU 210 or other computer system can configure the data file to include n rows, e.g., rows 402-1 to 402-n, where n is an integer number. The rows 402-1 to 402-n, are also referred to herein individually or in combination as row(s) 402. Each row 402 corresponds to a separate timestamp of the timestamps 404. The GPU 210 or other computer system can configure the data file to include m columns, e.g., columns 406-1 to 406-m, where m is an integer number. The columns 406-1 to 406-m are also referred to herein individually or in combination as column(s) 406. The GPU 210 or other computer system can assign to each column 406 a corresponding data field or data element type or category. For instance, column 406-1 can store ego velocity values for different timestamps or time values. Column 406-2 can store tensors of a first type, referred to herein as “tensor A,” for various timestamps or time values. For example, tensors of “tensor A” type can carry road or traffic data at various timestamps or time values. In particular, the tensor to be stored in the cell at the intersection of row 402-1 and column 406-2 can carry road or traffic data corresponding to timestamp 1337.37. Column 406-3 can store tensors of a second type, referred to herein as “tensor B,” for various timestamps or time values. For example, tensors of “tensor B” type can carry extracted features associated with various timestamps or time values.

The GPU 210 or other computer system can use the timestamps 404 to index the rows 402. In other words, the timestamps 404 may not be stored in a separate column 406. Instead, the GPU 210 or other computer system can store the timestamps 404 in the header in association with data offsets of the rows indicative of memory positions of the rows. The GPU 210 or other computer system can store, for each row, the corresponding timestamp and the corresponding data offset in the header. For example, the GPU 210 or other computer system can store the timestamps and the data offsets according to the order of the corresponding rows. The GPU 210 or other computer system can then store in each row of the data file the data elements associated with the same timestamp corresponding to the row.

For each row 402, the corresponding data offset can be expressed in units of data, such as Bytes. The data offset of a give row 402 can represent the distance or separation in data units between the start of the row in memory and some reference memory position. The reference memory position can be memory location representing the start of the data file. In other words, the data offset of a row 402 can be viewed as the amount of data (in data units) preceding the row 402 in the data file.

In some implementations, the data can include at least one data element that is associated with all timestamps of the plurality of timestamps. In the other words, the at least one data element can be the same for every timestamp of the plurality of timestamps. For example, the vehicle make and model of the ego 140 would not change over time. Also, the map of the geographical location of the ego 140 may not change over some time interval spanned by the plurality of timestamps, e.g., depending on the speed of the ego 140. For such data elements, it would not be efficient to store the same data repeatedly across all the rows 402 within one or more columns.

In some implementations, when storing data in rows, the GPU 210 or other computer system can store a first data element having a first size to precede a second data element having a second size larger than the first size. For example, the GPU 210 or other computer system can store the columns 406 according to an increasing order of corresponding data sizes. For instance, the GPU 210 or other computer system can select the data field (or data element type) with smallest size to be stored in the first column 406-1, select the data field with the next smallest size to be stored in column 406-2, and so on till column 406-n where the data field having the largest size is stored. Ordering the columns or data elements in each data row according to an order of increasing data size further reduces the amount of data read or parsed when not all the data elements of a row are to be retrieved.

In some implementations, the GPU 210 or other computer system can apply dimension transposition to one or more tensors before storing in the data file. In other words, the GPU 210 or other computer system can store some tensor, e.g., tensor A or tensor B, in transposed form. In some implementations, the GPU 210 or other computer system can encrypt one or more data elements of one or more types before storing in the data file. For example, the GPU 210 or other computer system can store one or more tensors in encrypted form.

The GPU 210 or other computer system can determine that the at least one other data element is associated with, or is the same for, all of the plurality of timestamps. For example, the data can include an indication that data associated with a specific data field or data element type is not changing, or is the same, across all timestamps. For a data field or data element type having the same data across the plurality of timestamps, only a single corresponding data element may be present in the data indicating that the same data element applies across all timestamps. The GPU 210 or other computer system may parse the data to determine which data field(s) or data element type(s) have static data across the plurality of timestamps.

The GPU 210 or other computer system store the at least one data element that is associated with or is the same for all of the plurality of timestamps prior to the plurality of rows in the data file. In particular, the GPU 210 or other computer system can store a static data element once in the data file, e.g., before any of the rows 402, to avoid unnecessary redundancy and efficiently use memory resources. The GPU 210 or other computer system may store non-changing data elements in the header, between the header and the rows 402 or before the header.

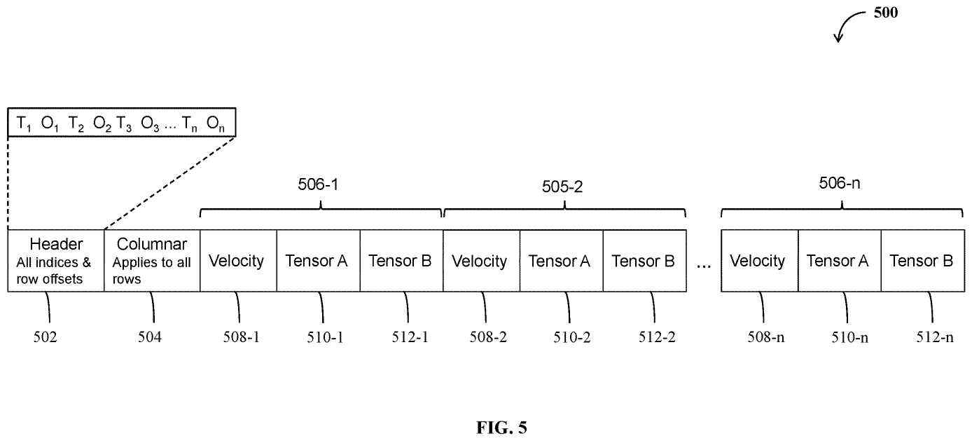

Referring now to FIG. 5, an example layout 500 of a memory layout of the file described in relation with FIG. 4 is shown, according to an example embodiment. As stored in memory, the data or the data file can be viewed as a plurality of contiguous data segments. A first data segment 502 can represent the header. A second data segment 504, referred to herein as columnar, can represent data element(s) with static or same values across the plurality of timestamps 402. The second data segment 504 can be followed by a sequence of data segments 506-1 through 506-n corresponding to the rows 402-1 through 402-n, respectively. For instance, data segment 506-1 can store a velocity value 508-1, an instance of tensor A 510-1 and an instance of tensor B 512-1 associated with row 402-1 in the data file. Data segment 506-2 can store a velocity value 508-2, an instance of tensor A 510-2 and an instance of tensor B 512-2 associated with row 402-2 of the data file and data segment 506-n can store a velocity value 508-n, an instance of tensor A 510-n and an instance of tensor B 512-n associated with row 402-n of the data file.

The data segment 502 representing the header can include a sequence of the timestamps 402, indicated as T₁, T₂, . . . , Tₙ, and the data offsets indicated as O₁, O₂, . . . , Oₙ. In some implementations, the GPU 210 or other computer system can store the timestamps 402 and the data offsets according to the order of the rows 402, by starting with timestamp T₁ and data offset O₁ of row 402-1 followed by timestamp T₂ and data offset O₂ of row 402-2 and so on till the timestamp Tₙ and data offset Oₙ of the last row 402-n. In some implementations, the header or data segment 502 can further include a data offset of the data segment 504, for example, at the beginning or at the end of the data segment 502.

In some implementations, the file format described above in relation to FIGS. 4-5 can have a corresponding extension. In some implementations, the file format extension can be “.smol”. In some implementations another extension can be used. Specific write and read operations that take into account the arrangement of data and the memory layout as described above in FIGS. 4-5 can be used with the file format. The write operations can be configured to generate data files of the data format that have a memory layout 500 as discussed in relation with FIG. 5. The write operations can be configured to take into consideration the memory layout 500 and read the header to identify data offsets of data row of interest and then move straight to memory positions corresponding to the data offsets in order to read or parse the data row of interest.

Referring back to FIG. 3, the method 300 can include the GPU 210 or other computer system determining, using an indication of a first timestamp and the header of the data file, a memory position of a row corresponding to a timestamp (STEP 306), and accessing at least one data element associated with the first timestamp using the determined memory position (STEP 308). In some implementations, the GPU 210 or other computer system can receive a request (e.g., an application programming interface) for the at least one data element. The request or call can include an indication of the first timestamp. The indication can include a time value. The GPU 210 or other computer system can use the indication to determine the first timestamp, e.g., as the timestamp closest to the indication or time value in the request.

The GPU 210 or other computer system can parse the header of the data file to determine the data offset corresponding to the first timestamp. The data offset corresponding to the first timestamp represents a memory position of the row 402 including the at least one data element, e.g., relative to the starting position of the data file. Responsive to determining the data offset, the GPU 210 or other computer system can skip to the memory position indicated by the data offset. For example, if the data offset is indicative of a memory position of the data segment 506-n corresponding to row 402-n, the GPU 210 or other computer system will not read or parse the data segments 506-1 through 506-n-1 and move straight to the memory position indicated by the data offset to read data segment 506-n corresponding to row 402-n. Upon reading data segment 506-n, the GPU 210 or other computer system can determine the requested at least one data element.

In some implementations, when multiple data elements from multiple rows 402 are to be read, the GPU 210 or other computer system can parse the header or portion thereof until the data offsets of all the rows of interest are determined. It is to be noted that the GPU 210 or other computer system does not need to parse the whole header and can stop at the point where all the relevant or needed data offsets are determined. Once the data offsets are determined, the GPU 210 or other computer system can start moving to the corresponding memory locations and reading the corresponding data segments representing corresponding rows sequentially. For example, if the GPU 210 or other computer system is to read instances of tensor A in rows 402-1 and 402-n-1, the GPU 210 or other computer system can parse the header to determine the data offsets O₁ and Oₙ₋₁ corresponding to timestamps T₁ and Tₙ₋₁, respectively. The GPU 210 or other computer system can move to the memory position corresponding to the data offset O₁ to read data segment 506-1 and then move to the memory position corresponding to the data offset Oₙ₋₁ to read data segment 506-(n-1).

In some implementations, the data file can be a read-only or non-editable data file. Preventing the data file from being edited maintains the layout structure depicted in FIG. 5. Typically, when a data file is edited, data is added at the end of the data file. As a result, any appended data will not be indexed in the header. For example, if the data file is edited to add one or additional rows, the header will not include the timestamps and the data offsets of the added rows, which would create a confusion with respect to reading data from the datafile. In particular, a read operation (as described above) to read data elements from any of the added rows would fail since such data rows are not reflected in the header.

Storing the timestamp and the data offset of each row in the header enables fast random access of any of the row 402 of the data file. Specifically, the amount of data parsed when reading one or more data elements from the data file is significantly reduced leading to reduction in the execution time of a read operation. Furthermore, the number of system input/output operations is reduced as multiple data elements at different locations in the data file can be read in a single read operation. Also, when generating the data file, the number of write operations is reduced by writing data elements that are the same for all timestamps only once in the data file.

At step 310, the method 300 can include the GPU 210 or other computer system training a ML model using data stored and retrieved in accordance with the methods and systems discussed herein. In particular, the GPU 210 or other computer system can use the at least one data element associated with the first timestamp to train a ML model, such as an occupancy network. The GPU 210 or other computer system can use the data stored in the data file to perform one or more training steps of the ML model.

While method 300 is described above in relation to a predefined file format, the same steps can be applied to store data to memory and read the data from memory. In other words, data can be written or stored in a memory region according to the memory layout 500 of FIG. 5 and can be read by taking into account the same memory layout without a predefined file format. Data can be stored according to a plurality of indexed data segment, e.g., not necessarily data rows. Also, while method 300 is described in terms of timestamps, any type of indices can be used to index the data segments or data rows. Finally, embodiments described herein can be used in other applications and are not to be restricted or limited to training or validation of ML models.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
obtaining, by a processor, ego navigation data including a plurality of data elements associated with a plurality of indices, each index associated with one or more data elements, the ego navigation data determined based on data captured by at least one sensor of an ego;
generating, by the processor, a data file storing the data according to a predefined file format including a header and a plurality of data rows, each data row corresponding to a respective index and storing the one or more data elements associated with the respective index, the header including, for each data row, an association between the respective index and a corresponding data offset indicative of a memory position of the data row;
determining, by the processor, using an indication of a first index and the header, a first memory position of a data row corresponding to the first index;
accessing, by the processor, using the first memory position, at least one data element associated with the first index; and
using, by the processor, the at least one data element associated with the first index to train a machine learning (ML) model.

2. The method of claim 1, wherein the ego navigation data is used to train an occupancy network of the ego, the occupancy network used to predict or sense surroundings of the ego.

3. The method of claim 1, wherein the data further includes at least one other data element that is associated with all of the plurality of indices, the method further comprising:
determining, by the processor, that the at least one other data element is associated with all of the plurality of indices; and
storing, by the processor, the at least one other data element prior to the plurality of data rows in the data file.

4. The method of claim 1, wherein the data file is a read-only data file.

5. The method of claim 1, wherein the data file stores the plurality of data elements according to a plurality of columns, each column representing a corresponding data field, the method further comprising arranging the plurality of columns according to an increasing order of data sizes associated with the plurality of data columns.

6. The method of claim 1, wherein the plurality of indices includes a plurality of timestamps or a plurality of time values.

7. The method of claim 1, wherein the plurality of data elements include a plurality of tensors and each data row stores one or more tensors associated with the respective index corresponding to the data row.

8. The method of claim 7, further comprising at least one of:
transposing, by the processor, at least a subset of the tensors before storing in the data file; or
encrypting, by the processor, at least a subset of the tensors before storing in the data file.

9. The method of claim 1, further comprising:
receiving, by the processor, a request for the at least one data element associated with the first index, the request including the indication of the first index;
determining, by the processor, the first index using the indication.

10. The method of claim 1, wherein accessing the at least one data element associated with the first index includes:
skipping, by the processor, upon determining the first memory position of the data row corresponding to the first index, from a second memory position associated with the header to the first memory position.

11. A computer system comprising:
a processor; and
a memory storing executable instructions, the executable instructions, when executed by the processor, cause the computer system to:
obtain ego navigation data including a plurality of data elements associated with a plurality of indices, each index associated with one or more data elements, the ego navigation data determined based on data captured by at least one sensor of an ego;
generate a data file storing the plurality of data elements according to a predefined file format including a header and a plurality of data rows, each data row corresponding to a respective index and storing the one or more data elements associated with the respective index, the header including, for each row, an association between the respective index and a corresponding data offset indicative of a memory position of the data row;
determine, using an indication of a first index and the header, a first memory position of a data row corresponding to the first index;
access, using the first memory position, at least one data element associated with the first index; and
use the at least one data element associated with the first index to train a machine learning (ML) model.

12. The computer system of claim 11, wherein the ego navigation data is used to train an occupancy network of the ego, the occupancy network used to predict or sense surroundings of the ego.

13. The computer system of claim 11, wherein the data further includes at least one other data element that is associated with all of the plurality of indices, the executable instructions, when executed by the processor, further cause the computer system to:
determine that the at least one other data element is associated with all of the plurality of indices; and
store the at least one other data element prior to the plurality of data rows in the data file.

14. The computer system of claim 11, wherein the data file is a read-only data file.

15. The computer system of claim 11, wherein the executable instructions, when executed by the processor, cause the computer system to:
store the plurality of data elements according to a plurality of columns in the data file, each column representing a corresponding data field; and
arrange the plurality of columns according to an increasing order of data sizes associated with the plurality of data columns.

16. The computer system of claim 11, wherein the plurality of indices includes a plurality of timestamps or time values.

17. The computer system of claim 11, wherein the plurality of data elements include a plurality of tensors and each data row stores one or more tensors associated with the respective index.

18. The computer system of claim 17, wherein the executable instructions, when executed by the processor, further cause the computer system to perform at least one of:
transpose at least a first subset of the tensors before storing in the data file; or
encrypt at least a second subset of the tensors before storing in the data file.

19. The computer system of claim 1, wherein in accessing the at least one data element associated with the first index, the executable instructions, when executed by the processor, cause the computer system to skip, upon determining the first memory position of the row corresponding to the first timestamp, from a second memory position associated with the header to the first memory position.

20. A non-transitory computer-readable medium storing computer code instructions thereon, the computer code instructions when executed by a processor cause the processor to:
obtain ego navigation data including a plurality of data elements associated with a plurality of indices, each index associated with one or more data elements, the ego navigation data determined based on data captured by at least one sensor of an ego;
generate a data file storing the plurality of data elements according to a predefined file format including a header and a plurality of data rows, each data row corresponding to a respective index and storing the one or more data elements associated with the respective index, the header including, for each row, an association between the respective index and a corresponding data offset indicative of a memory position of the data row;
determine, using an indication of a first index and the header, a first memory position of a data row corresponding to the first index;
access, using the first memory position, at least one data element associated with the first index; and
use the at least one data element associated with the first index to train a machine learning (ML) model.
